(19) United States
(12) Patent Application Publication
(10) Pub. No.: US 2006/0181082 A1
(43) Pub. Date: Aug. 17, 2006

(54) Bullthread

(76) Inventor: Franklin E. Gray, Glendora, CA (US)

Correspondence Address: MERCHANT & GOULD PC, P.O. BOX 2903, MINNEAPOLIS, MN, 55402-0903, US

(21) Appl. No.: 11/401,681

(22) Filed: Apr. 10, 2006

Related U.S. Application Data
(63) Continuation-in-part of application No. 10/269,747, filed on Oct. 4, 2002.
(60) Provisional application No. 60/327,392, filed on Oct. 4, 2001.

(51) Int. Cl. F16L 15/00

(52) U.S. Cl. 285/901; 285/390

(57) ABSTRACT

A connector for use in combination with piping to transform plumbing pipe stub outs to re-sealable leak-proof open or closed stub outs. The connector is an elongated hollow cylindrical brass fitting having first and second ends wherein the first end slides into an open end of a copper stub out pipe and securely attached thereto. The second end of the elongated hollow cylindrical brass fitting has a threaded interior surface that is configured as a female threaded receptor to engage a male threaded plug. The threaded plug removably engages the second end of the elongated hollow cylindrical brass fitting by screwing into or out of the elongated hollow cylindrical brass fitting. The insertion and removal of the threaded plug allows for the drain of debris, pressure testing and inspection of the copper piping throughout a newly constructed building without the traditional cutting and recapping now permanently closed stub outs which may have been bullet stub outs or stub outs that have been soldered closed.

### CROSS REFERENCE TO RELATED APPLICATIONS

This is a Continuation-In-Part of application Ser. No. 10/269,747, filed on Oct. 2, 2002 which claims priority from provisional application Ser. No. 60/327,392, filed Oct. 4, 2001.

### FIELD OF THE INVENTION

The present invention relates an apparatus to be used in the plumbing field or any water, waste water or air applications where fixture stub outs are used during rough construction, new construction, and for replacement of existing fixture stub outs.

### BACKGROUND OF THE INVENTION

New building construction plumbing used specifically for water applications has been traditionally implemented by extending copper or other rigid tubing behind and parallel to walls, floors and ceilings of the building and then out of a hole in the interior surface wall and terminating as a stub out. A popular stub out configuration currently being used in new building construction by plumbers is a spun closed “bullet” stub out.

During building construction, following installation of the interior surface wall around the protruding plumbing pipe stub out, pressure tests are run on the plumbing pipe assembly. One of the problems resulting from the use of the spun closed “bullet” stub out in new construction plumbing is that the inspector, home owner and builder has no way of testing the pipe assembly to determine whether the plumber has done an accurate job with the connection and extension of the plumbing pipe throughout the building. This is because of the closed copper tip on the “bullet” that extends away from the building wall and then out of a hole in the interior surface wall. Another problem resulting from completion of the building and plumbing assembly is that the pipes may have debris that has accumulated therein. A builder or plumber needs to have the ability to blow out any such accumulated debris. Debris cannot be blown out of the pipe assembly nor can it be tested without opening the closed copper tip on the “bullet” stub out. The only known method for opening a “bullet” stub out is to cut the tip off. After the “bullet” stub out tip is opened, it has to be closed again. Closing of the tip is performed by brazing a cap onto the end of the extending pipe. There is a need for a stub out assembly that is sealed and can then be resealed without the steps of cutting copper pipe and brazing a cap onto the end of the stub out.

One structure that provides a stub out that is sealed and can be opened and resealed is a male iron pipe (“MIP”) adapter or female iron pipe (“FIP”) adapter with a PVC cap on the end. The problem with using an MIP or FIP adapter in a plumbing environment as a stub out to which it is desired to attach a toilet or any other apparatus that needs to be connected to the building water supply, is that the MIP or FIP adapter size does not allow for the use of plumbing shelf products such as an escutcheon ring. There is a need for a stub out that is sealed and can be opened and resealed without the steps of cutting copper pipe and brazing a cap onto the end of the stub out while maintaining the integrity of the copper pipe assembly so that existing plumbing shelf products may be used.

### BRIEF DESCRIPTION OF THE DRAWINGS

FIG. 1 is a perspective view of the connector portion of an embodiment of the invention attached to a copper pipe;

FIG. 2 is an enlarged, cross-sectional view of a female embodiment of the connector portion of the invention connected to a copper pipe;

FIG. 3 is an exploded perspective view of an embodiment of the invention;

FIG. 4 is a top view of an embodiment of the connector portion of the invention;

FIG. 5 is a cross-sectional view of a male embodiment of the invention. Connected to a copper pipe.

### SUMMARY OF THE INVENTION

It is an object of the present invention to provide a re-sealable plumbing stub out, wherein the end of the stub out to which plumbing fixtures would be attached has a threaded section at a first end that allows a removable seal to threadingly engage the stub out to create a leak proof seal. In one embodiment the re-sealable plumbing stub out can be a one piece assembly and/or pre-assembled. The threaded section of the invention in one embodiment of the stub out comprise female threads. In another embodiment, the threaded section of the stub out comprises male threads. The threaded end of the stub out may remain open or be closed by a threaded male plug that is screwed into the threaded end of the stub configured as a female member for the threaded connection. Alternatively, when the threaded end of the stub out has a threaded section on the exterior walls of a section of the first end of the stub out, it may be capped by a female cap that is screwed over the threaded end of the stub out which acts as a male threaded connector.

It is the object of the invention to provide a leak proof stub out for use with piping in plumbing construction. The stub out has a removable plug or cap that provides a leak proof seal at the stub out when engaged and provides an open end to the stub out when the plug is removed. The plug or cap may be removed and securely engaged without the need to solder or cut the stub out pipe.

It is a further object of the present invention to remove the step of cutting copper or rigid piping when it is desirable to attach an angle stop. It is a further object of the present invention to provide a cap or plug for the stub out that is reusable and void of mess and expense associated with soldering and removal of soldered plug and caps on pipe stub outs. In a preferred embodiment of the present invention the cap or plug for the stub out is made of a polymer that will form a leak proof seal with the stub out, for example, Teflon®.

The invention is an elongated hollow cylindrical rigid stub out pipe fitting having first and second ends. The second end of the elongated hollow cylindrical rigid fitting has a threaded section on its interior or exterior surface. The threaded section may be configured so that the elongated hollow cylindrical metal stub out is a female receptor that engages a male threaded plug; or it may be configured so that the elongated hollow cylindrical rigid stub out is a male threaded connector that engages a female threaded cap. The threaded plug or cap removably engages the threaded section of the stub out pipe and securely attached thereto.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is to be used as a re-sealable plumbing stub out during construction of rigid piping systems. In the present embodiment, each re-sealable plumbing stub out is comprised of an open ended copper pipe and an elongated hollow cylindrical brass fitting having an inner collar and an outer collar. It is to be understood that the present invention may be comprised of a metal or other rigid material sufficient to allow the invention to be soldered to the material in which it is being connected to. In the preferred embodiment, the metal is brass. In an alternative embodiment, for example, if the invention is to be connected to a copper or zinc pipe then the invention can be made of brass which is an alloy of copper and zinc. The fact that the present embodiment is identified as utilizing brass and copper is not intended to limit the invention to requiring two pieces of metal that require soldering to generate a re-sealable plumbing stub out. The invention may be a one-piece apparatus comprised of one type of rigid material. In addition, regarding the aspect of soldering the open ended copper pipe and an elongated hollow cylindrical brass fitting, it is to be understood that it is contemplated that the soldering done is not to be limited to traditional types of soldering and should include the use of silver solder and other means of attaching open ended copper pipe and an elongated hollow cylindrical brass fitting.

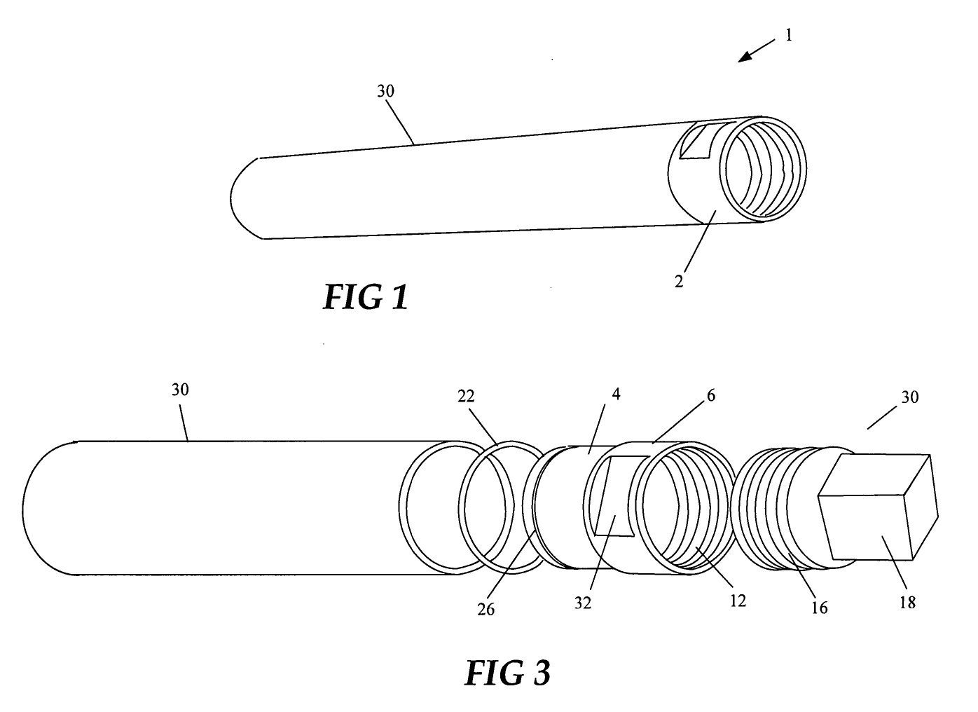

In the embodiment illustrated in FIG. 1, the elongated hollow cylindrical brass fitting 2 is one inch in length. The diameter of the elongated hollow cylindrical brass fitting 2 may be one-half inch, three-fourths inch or one inch. It is to be understood that the diameter of the elongated hollow cylindrical brass fitting 2 is dependent upon the size of copper pipe 30 being used in the plumbing construction. The diameter of the elongated hollow cylindrical brass fitting 2 is of a diameter relative to that of the copper pipe 30 to allow a portion of it to slide into the copper pipe 30.

Referring to FIG. 1, an open ended stub out 1 is shown. The stub out 1 is comprised of an elongated hollow cylindrical brass fitting 2 permanently attached to a copper pipe 30. In the present embodiment, the elongated hollow cylindrical brass fitting 2 is permanently attached to the copper pipe 30 by inserting the inner collar (not shown) of the elongated hollow cylindrical brass fitting 2 into the copper pipe 30 and soldering them together. It is to be understood that the present invention is not intended to be limited to permanent attachment of the elongated hollow cylindrical brass fitting 2 to the copper pipe 30 by way of soldering. The present invention is intended to cover any method of permanently or semi permanently attaching the elongated hollow cylindrical brass fitting 2 to the copper pipe 30. It is to be further understood that the present invention is intended to encompass any means of attaching the elongated hollow cylindrical brass fitting 2 to copper pipe 30 whereby the attached thereto is leak proof, even if the attachment is not permanent. It is to be also understood that the open ended stub out 1, including the elongated hollow cylindrical brass fitting 2 and the copper pipe 30 may be a single configuration.

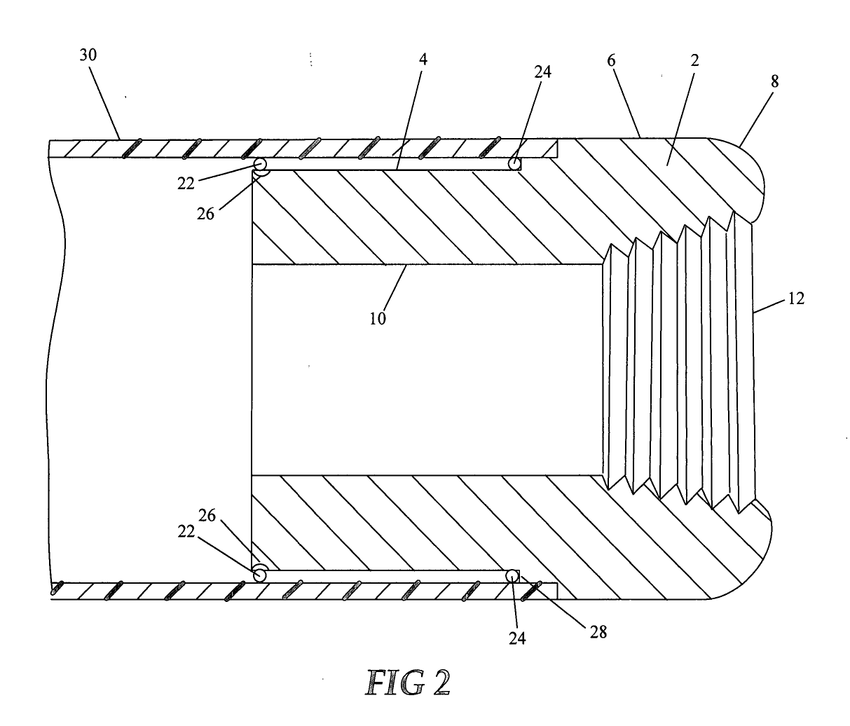

As illustrated in FIGS. 2 and 3, the elongated hollow cylindrical brass fitting 2 has an inner collar 4 and an outer collar 6. The inner collar 4 of the elongated hollow cylindrical brass fitting 2 is a male insert that slides into an open end of a copper pipe 30 and is soldered in place. The outer collar 6 of the elongated hollow cylindrical brass fitting 2 has a rounded tip 8. The interior surface 10 of the inner collar 4 has a smooth surface. The interior surface 12 of the outer collar 6 is threaded. The threaded surface 12 of the outer collar 6 is configured as a female portion of the elongated hollow cylindrical brass fitting 2 so that it may receive a threaded plug 14.

The threaded plug 14 has a threaded male portion 16 and a tool-gripping portion 18. The threaded plug 14 removably engages the threaded surface 12 of the outer collar 6 by screwing the threaded plug 14 into the elongated hollow cylindrical brass fitting 2 to create a leak proof plug. This occurs following the secure soldering of the elongated hollow cylindrical brass fitting 2 to an open end of copper pipe 30.

The threaded plug 14 is leak proof once fully screwed in the appropriate direction and may be removed by screwing the threaded plug 14 in the opposite direction. Since the threaded plug 14 is screwed in place into the elongated hollow cylindrical brass fitting 2 instead of being soldered, it can be removed and replaced as needed. The insertion and removal of the threaded plug 14 allows for the draining of debris, pressure testing and inspection of the copper piping throughout a newly constructed building without the traditional cutting and re-capping of permanently closed bullet stub outs or stub outs that are soldered closed.

In an alternative embodiment (not shown), the outer collar is threaded on the exterior surface forming a male receptor for receiving a threaded cap. The threaded cap has a tool-gripping portion. The threaded cap removably engages the male receptor by screwing the thread cap onto the elongated hollow cylindrical brass fitting to create a leak proof seal.

Referring to FIG. 2, a sectional view of the elongated hollow cylindrical brass fitting 2, copper pipe 30 is shown in a preferred embodiment. The elongated hollow cylindrical brass fitting 2 has an inner collar 4 and an outer collar 6. The inner collar 4 is comprised of a step 28. The step 28 provides a space between the inner collar 4 and the interior wall of the copper pipe 30. During assembly, two soldering bands 22, 24 are placed on the step to attach the elongated hollow cylindrical brass fitting 2, and then the inner collar 4 is inserted into an open end of the copper pipe 30. The assembly is then heated to approximately 1800° F. to secure the copper pipe 30 to the elongated hollow cylindrical brass fitting 2. In a preferred embodiment, the inner collar 4 further comprises a notch 26 for receiving an aid in sealing the connection between the elongated hollow cylindrical brass fitting 2 and the copper pipe 30. For example, the notch 26 may retain the second solder band 22 or some other gasket.

FIG. 3 illustrates an exploded assembly view of a stub out that may be sealed, unsealed, and resealed. The stub out is comprised of a copper pipe 30, elongated hollow cylindrical brass fitting 2, and threaded plug 14. The frontal view of the elongated hollow cylindrical brass fitting 2 illustrates the inner collar 4, outer collar 6, threaded interior surface 12 of the outer collar 6 and a first planar portion 32. The elongated hollow cylindrical brass fitting 2 is soldered to the copper pipe 30 after being inserted the copper pipe 30, thereby forming an open end copper stub out. The re-sealable stub out illustrated in FIG. 3 may be transformed from an open end stub out to a closed stub out by screwing the threaded plug 14 into the outer collar 6 of the elongated hollow cylindrical brass fitting 2.

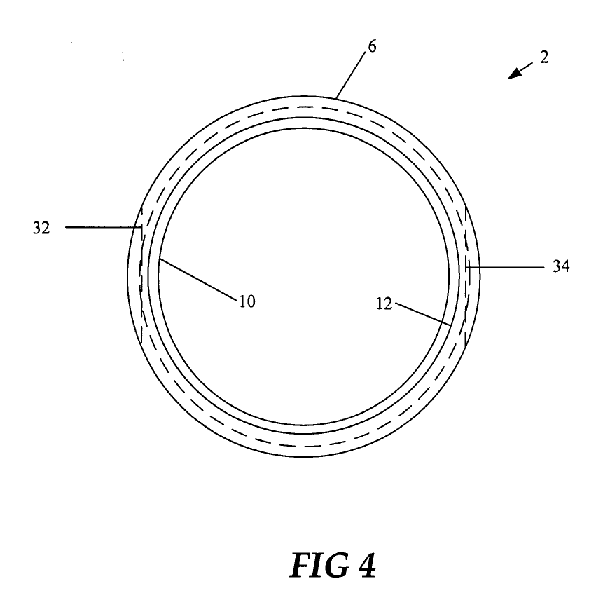

FIG. 4 is a top view of the elongated hollow cylindrical brass fitting 2, illustrating the outer collar 6 of the elongated hollow cylindrical brass fitting 2 and the opposed first and second planar portions 32, 34 of the outer collar 6.

In one embodiment, the elongated hollow cylindrical brass fitting 2 is one-half inch in diameter and one inch in length. The brass fitting is created by drilling a through hole in a solid brass billet, using a one-fourth inch drill bit suitable for drilling metals, such as twist bits. The threaded inner surface 12 of the outer collar is constructed using standard tapping techniques. In one embodiment, the threaded inner surface 12 of the outer collar 6 is configured with one-fourth inch tapered threads. In alternative embodiments the threaded inner surface of the outer collar may be configured with seven-sixteenth, one-half, three-eighth or five-sixteenth inch-tapered threads. It is to be understood that it is contemplated that the dimensions of the threaded inner surface of the outer collar may be any dimensions so long as the threads allow for a leak proof seal.

In another embodiment, the elongated hollow cylindrical brass fitting 2 is three-fourths of an inch in diameter and one inch in length. The brass fitting is created by drilling a through hole in a solid brass billet, using a three-fourths inch drill bit suitable for drilling metals, such as twist bits. The threaded inner surface 12 of the outer collar 6 is constructed using standard tapping techniques. In one embodiment, the threaded inner surface of the outer collar is configured with three-fourths inch-tapered threads.

In another embodiment, the elongated hollow cylindrical brass fitting 2 is one and one half inch in diameter and one inch in length. The brass fitting is created by drilling a through hole in a solid brass billet, using a one-inch drill bit suitable for drilling metals. The threaded inner surface 12 of the outer collar is constructed using standard tapping techniques.

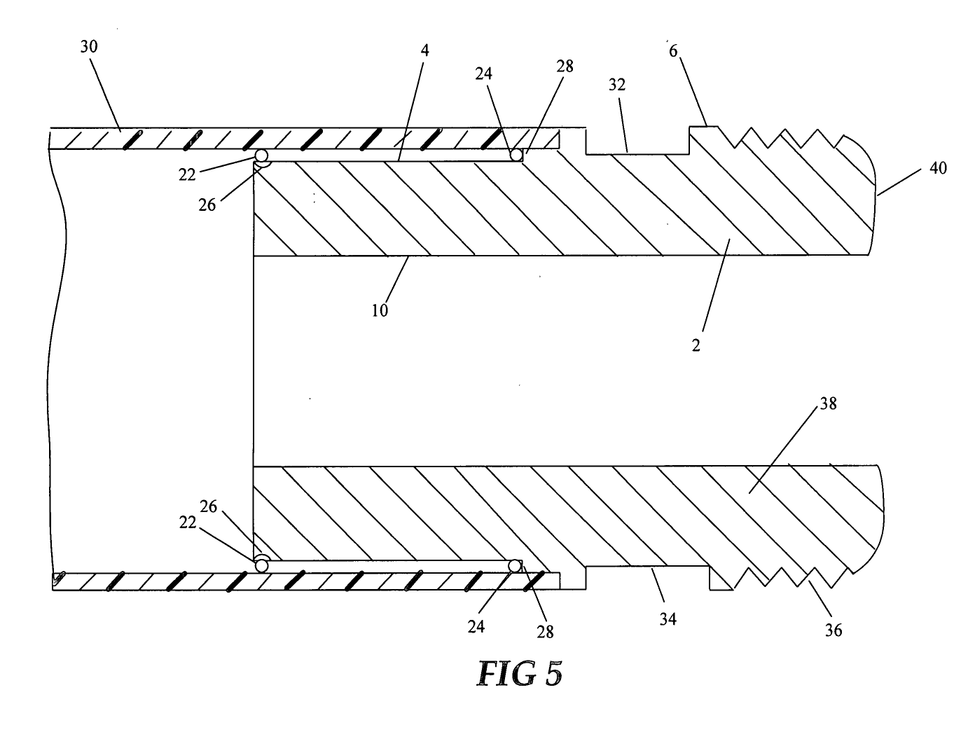

Referring to FIG. 5, a sectional view of the elongated hollow cylindrical brass fitting 38, copper pipe 30 is shown in a alternate embodiment. The elongated hollow cylindrical brass fitting 38 has an inner collar 4 and an outer collar 6. The inner collar 4 is comprised of a step 28. The step 28 provides a space between the inner collar 4 and the interior wall of the copper pipe 30. During assembly, two soldering bands 22, 24 are placed on the step to attach the elongated hollow cylindrical brass fitting 38, and then the inner collar 4 is inserted into an open end of the copper pipe 30. The assembly is then heated to approximately 1800° F. to secure the copper pipe 30 to the elongated hollow cylindrical brass fitting 38. In a preferred embodiment, the inner collar 4 further comprises a notch 26 for receiving the second solder band 22.

In one embodiment, the elongated hollow cylindrical brass fitting 38 is created by drilling a through hole in a solid brass billet, using a one-fourth inch drill bit suitable for drilling metals, such as twist bits. The outer collar 6 is comprised of opposed first and second planar portions 32, 34 of the outer collar 6, and a threaded section 36 for engaging a threaded cap. The threaded section 36 is formed using a standard die for creating threads. It is to be understood that the first and second planar portions 32, 34 are of a suitable size to allow a tool, such as a wrench, to engage the elongated hollow cylindrical brass fitting 38 while the threaded cap is being applied. It is also to be understood that the threaded section 36 extends form the front edge 40 of the elongated hollow cylindrical brass fitting 38 for a distance of not less than one-quarter inch. It is also to be understood that the threaded section 36 does not overlap the first and second planar portions 32, 34.

In one embodiment, the threaded inner surface of the outer collar is configured with one-fourth inch tapered threads. In alternative embodiments the threaded inner surface of the outer collar may be configured with seven-sixteenth, one-half, three-eighth or five-sixteenth inch-tapered threads. It is to be understood that it is contemplated that the dimensions of the threaded inner surface of the outer collar may be any dimensions so long as the threads allow for a leak proof seal.

It is foreseen that the elongated hollow cylindrical brass fitting could be adapted for use in other piping construction environments other than plumbing stub out applications and the invention is not to be considered limited to the environment shown. In addition the dimensions provided are simply for use in describing preferred embodiments adapted for use with conventional plumbing pipe stub outs of generally standardized dimensions. However, the dimensions provided above should not be deemed limiting and it is foreseen that the dimensions of the pipes could be changed to accommodate various applications. It is thus to be understood that while certain forms of the present invention have been illustrated and described herein, it is not to be limited to the specific forms or arrangement of parts described and shown.

What is claimed:

1. A re-sealable plumbing stub out adapter comprising:
a. an elongated hollow cylindrical fitting having a first end and a second end;
b. a threaded removable seal;
wherein said first end is to be attached to a stub out, wherein said second end has a threaded surface that allows a removable seal to threadingly engage said elongated hollow cylindrical fitting whereby a leak resistant seal is formed.

2. The stub out adapter of claim 1 wherein said elongated hollow cylindrical fitting is comprised of metal.

3. The stub out adapter of claim 2 wherein said elongated hollow cylindrical metal fitting is comprised of brass.

4. The stub out adapter of claim 1 wherein said removable seal is comprised of a threaded male plug.

5. The stub out adapter of claim 4 wherein said threaded male plug is comprised of Teflon®.

6. The stub out adapter of claim 1 wherein said removable seal is comprised of a threaded female cap.

7. The stub out adapter of claim 6 wherein said threaded female cap is comprised of Teflon®.

8. The stub out adapter of claim 1 wherein said second end of said elongated hollow cylindrical fitting has threads on the inner surface of the second end of said elongated hollow cylindrical fitting for engaging a male threaded plug.

9. The stub out adapter of claim 1 wherein said second end of said elongated hollow cylindrical fitting has threads on the outer surface of the second end of said elongated hollow cylindrical fitting for engaging a female threaded cap.

10. The stub out adapter of claim 1 wherein second end of said elongated hollow cylindrical fitting has first and second planar portions.

11. The stub out adapter of claim 10 wherein said first and second planar portions are directly opposed.

12. The stub out adapter of claim 1 wherein said first end has a notch located in the exterior surface.

13. The stub out adapter of claim 12 wherein said notch contains a soldering band.

14. An elongated hollow cylindrical stub out having first and second ends wherein said first end has threads on a portion of its interior surface that allow said stub out to be plugged with a threaded plug that engages said first end of said stub out by screwing the plug into said first end, wherein the first end of the stub out is comprised of an elongated hollow cylindrical fitting having first and second ends, and the second end of the stub out is a section of pipe, said elongated hollow cylindrical fitting is securely attached to said section of pipe as a male insert.
